(19) United States
(12) Patent Application Publication
(10) Pub. No.: US 2019/0306208 A1
(43) Pub. Date: Oct. 3, 2019

(54) COMPUTER SYSTEM AND METHOD FOR FACILITATING DEBATE

(71) Applicant: DISTRIMATION, LLC, Grosse Pointe Farms, MI (US)

(72) Inventor: Thomas Alan Robinson, Saint Clair Shores, MI (US)

(73) Assignee: DISTRIMATION, LLC, Grosse Pointe Farms, MI (US)

(21) Appl. No.: 16/368,373

(22) Filed: Mar. 28, 2019

Related U.S. Application Data
(60) Provisional application No. 62/649,881, filed on Mar. 29, 2018.

(51) Int. Cl. H04L 29/06; H04L 29/08; G06F 17/27; G06N 20/00

(52) U.S. Cl. CPC H04L 65/4015; H04L 67/10; G06F 3/04847; G06N 20/00; G06F 17/2765

(57) ABSTRACT

A computing device and computer-implemented method of facilitating a debate includes a user choosing a topic that he/she wishes to debate and inviting a second user to the debate. The users also agree on which of the opposite positions on the topic each wishes to represent. Each debate round will begin with a user providing a first communication. The other user can be notified of the first communication and be given an opportunity to respond. The users then are permitted to take turns and comment back-and-forth, where the number of back-and-forth communications (rounds) can be limited in number. The length of each communication can also or alternatively be character or word limited to ensure concise comments. Each of the users can be permitted to enter a final summary or summation of the debate, which can have a longer character/word limit than the typical communications.

### CROSS-REFERENCE TO RELATED APPLICATION

This application claims the benefit of U.S. Provisional Application No. 62/649,881, filed on Mar. 29, 2018. The disclosure of the above application is incorporated herein by reference in its entirety.

### FIELD

The present disclosure relates to a computerized system and method for social networking, more particularly, to a computer program, application, website, or other computer implemented technique for fostering and encouraging a debate about a given topic.

### BACKGROUND

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

It is paradoxical that, in a modern world that seemingly provides a nearly unlimited number of ways of communicating with others, meaningful communication between people having different viewpoints is rare. While the Internet, including social media, provides a mechanism for a person to share her/his thoughts on a topic, this same mechanism may permit others to deflect the “conversation” about the topic such that the conversation is no longer informative or useful. Utilizing typical social media via the Internet, a constructive dialogue between two people or groups that disagree on a specific topic is difficult at best, and at worst quickly turns into threats, insults, and other ad hominem attacks (as anyone who has read a comments section of an online newspaper can attest). It would be desirable to provide an improved system and computer-implemented method that permits people to have a constructive debate.

### SUMMARY

In various embodiments of the present disclosure, an improved system and computer-implemented method that permits people to have a constructive debate via a computer application and/or website is disclosed. A system and computer-implemented method of facilitating a debate (a “debate application”) are presented. A user (or group of users) chooses a topic that he/she wishes to debate and invites a second user (or group of users) to the debate. The users also agree on which of the opposite positions on the topic each wishes to represent.

A computer-implemented method for facilitating debate between a first user and a second user includes receiving, at a computing device have one or more processors, a request to begin a debate. The request can be from the first user and identifying a topic of the debate, a number of rounds for the debate, and the second user. The method can also include initiating, at the computing device, each round of the debate during which the first and second user alternate providing communications regarding the topic to the computing device. During each round of the debate, various operations can occur. A communication from the first user can be received at the computing device. The communication can provide a first position on the topic and comprise a first argument purporting to support the first position. Upon receiving the communication, the communication can be transmitted, from the computing device, to the second user, and a timer can be started. The timer can be used to track a response period, where the response period provides a time limit in which the second user is permitted to respond to the communication. The response period can further include a reminder period shorter than the response period. When the second user has not provided a response within the reminder period, a reminder communication, from the computing device, can be provided to the second user indicative of the response period. When the second user has not provided the response within the response period, a forfeit communication can be transmitted to the first and second users indicating that the second user has forfeited their turn for the round. However, when the second user provides the response within the response period, the response can be transmitted to the first user. The response can provide a second position on the topic different from the first position and include a second argument purporting to support the second position. When the second user has either (i) forfeited their turn for the round, or (ii) provided the response for the round within the response period: the round can be ended. When there are no remaining rounds in the number of rounds, the debate can be concluded the debate by prompting the first and second users to provide a first and second summation, respectively, of their respective positions. The computing device can then simultaneously transmit the first summation to the second user and the second summation to the first user upon receipt of: (i) both the first and second summations, or (ii) an end of a summation period.

In other aspects, a computing device configured for facilitating debate between a first user and a second user can include one or more processors, and a non-transitory computer-readable storage medium having a plurality of instructions stored thereon, which, when executed by the one or more processors, cause the one or more processors to perform the method described above.

Further areas of applicability of the present disclosure will become apparent from the detailed description provided hereinafter. It should be understood that the detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1 is a diagram of a computing system including an example computing device according to some implementations of the present disclosure;

FIG. 2 is a functional block diagram of the example computing device of FIG. 1

FIG. 3 is an example graphical user interface corresponding to a landing page of a social network debate application or website according to some implementations of the present disclosure;

FIG. 4 is an example graphical user interface corresponding to a “Guidelines” page of a social network debate application or website according to some implementations of the present disclosure;

FIG. 5 is an example graphical user interface corresponding to a home page of a social network debate application or website according to some implementations of the present disclosure;

FIG. 6 is another example graphical user interface corresponding to a home page of a social network debate application or website according to some implementations of the present disclosure;

FIG. 7 is an example graphical user interface corresponding to a “Create Debate” page of a social network debate application or website according to some implementations of the present disclosure; and

FIG. 8 is a flow diagram of an example technique for facilitating debate according to some implementations of the present disclosure.

### DETAILED DESCRIPTION

As previously discussed, while the Internet provides many mechanisms for a person to share her/his thoughts on a topic, there exists a need for an improved system and computer-implemented method that permits people to have a constructive debate via a computer application and/or website. Accordingly, a computing device or system and computer-implemented method of facilitating a debate are presented. It is contemplated that this will be implemented in a computer application or website accessible to users. A user (or group of users) chooses a topic that he/she wishes to debate and invites a second user (or group of users) to the debate. The users also agree on which of the opposite positions on the topic each wishes to represent.

One of the users can request to begin the debate by providing a topic for the debate, a number of rounds for the debate, and an identification of the other participant(s) in the debate. Each debate round will begin with a user providing a first communication. The other user can be notified of the first communication and be given an opportunity (and possibly a time limit in which) to respond. The users then are permitted to take turns and comment back-and-forth, where the number of back-and-forth communications (rounds) can be limited to a certain number of responses (5, 10, etc.). In certain aspects, the length of each communication can also or alternatively be character or word limited to ensure concise comments. Finally, each of the users can be permitted to enter a final summary or summation of the debate, which (in some implementations) can have a longer character/word limit than the typical communications. Further, the debates (both during the debate and after completion of the debate) can be made available to non-participants for their review and, possibly, comments. In this manner, two users can have a meaningful debate about a topic that overcomes the limitations of traditional social network communication forums, including those described above and others.

There can be two different types of users: visitor users and participant users. Visitor users can be limited to viewing only particular debates, such as those described as “Headliner” debates described below. In other aspects, visitor users that register will have full access to any and all debates. Participant users are users that engage in debates.

Furthermore, there can be two different types of debates: Headliner debates and Street or normal debates. Headliner debates are debates between one or more well-known participants, such as celebrities, politicians, athletes, and other public/quasi-public figures. For example only, Headliner debates can include participant users that are renowned enough to have a large social media following. As mentioned above, Headliner debates can be made available to (e.g., can be viewed by) any user. Street debates can include all other debates and involve any registered user that wants to participate and finds a challenger. Such Street debates can made viewable only by people invited by the participant users. In some aspects, the participant users can choose to make a Street debate publicly available (available to all users, only registered users, etc.) if they so desire.

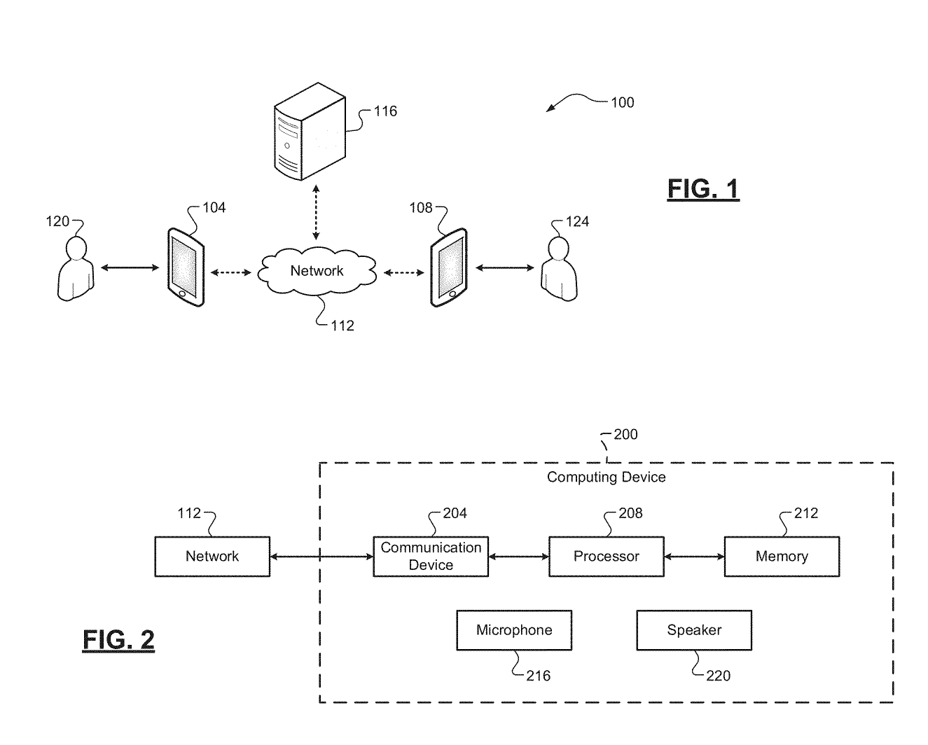

Referring now to FIG. 1, a diagram of an example computing system 100 is illustrated. The computing system 100 can include a first client computing device 104 that can communicate with a second client computing device 108 via a network 112. While mobile phone configurations of the client computing devices 104, 108 are illustrated, it will be appreciated that the first and second client computing devices 104, 108 can be any suitable computing devices configured for communication via the network 112 (desktop computers, laptop computers, tablet computers, etc.). The network 112 can be a cellular network (2G, 3G, 4G long term evolution (LTE), etc.), a computing network (local area network, the Internet, etc.), or some combination thereof. A server computing device 116 can also communicate via the network 112. For example only, the server computing device 116 could facilitate, implement, coordinate, manage, etc. a debate (e.g., via a debate application) between a first user 120 and a second user 124 associated with the first and second client computing devices 104, 108, respectively.

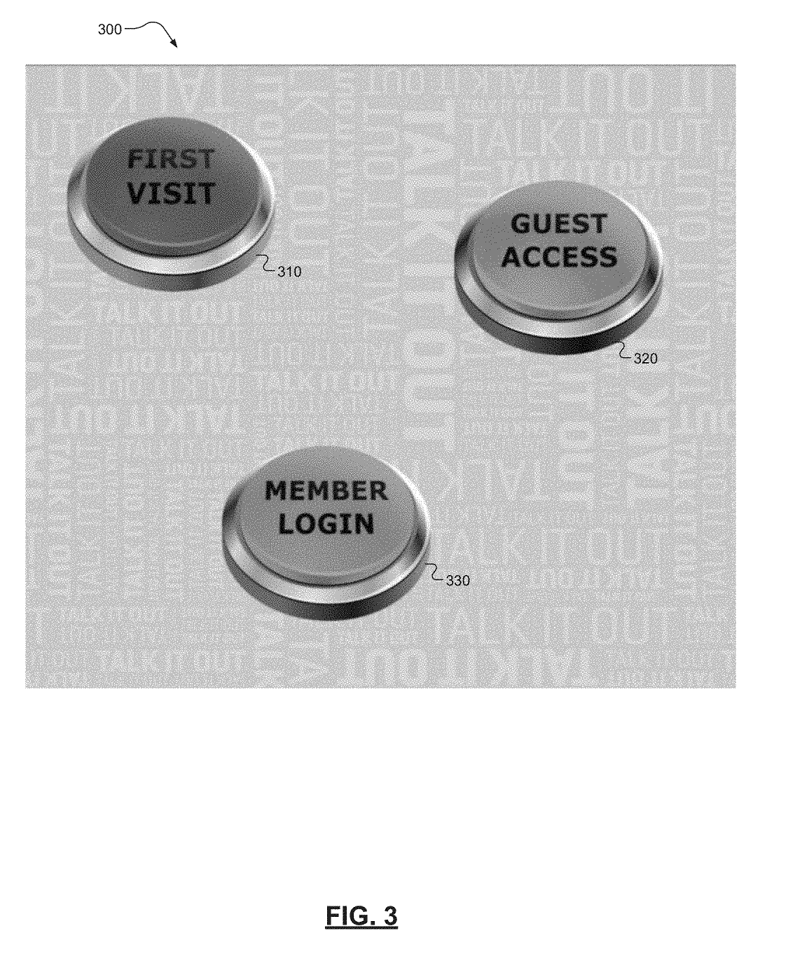

Referring now to FIG. 2, a functional block diagram of an example computing device 200 is illustrated. The computing device 200 can represent the configurations of the first and second computing devices 104, 108. It will be appreciated that the server computing device 116 could also have the same or similar configuration as the computing device 200. The computing device 200 can include a communication device 204 (e.g., a wireless transceiver) configured for communication via the network 112. A processor 208 can be configured to control operation of the computing device 200. The term “processor” as used herein can refer to both a single processor and two or more processors operating in a parallel or distributed architecture. A memory 212 can be any suitable storage medium (flash, hard disk, etc.) configured to store information at the computing device 200. In one implementation, the memory 212 can store instructions executable by the processor 208 to cause the computing device 200 to perform at least a portion of the disclosed techniques.

The computing device 200 can also include a microphone 216 configured to capture audio input and a speaker 220 configured to generate audio output. The microphone 216 can be any suitable acoustic-to electric transducer or sensor that converts sound into an electrical signal. This can include speech (e.g., by users 120, 124) as well as other noise, such as background noise. The speaker 220 can include a set of electroacoustic transducers that convert an electrical signal into a corresponding sound. While not shown, it will be appreciated that the computing device 200 can include other suitable components, such as a display (a touch display), physical buttons, a camera, and the like. As further described below, the example computing system 100 can be configured to perform various techniques for facilitating debate between debate participants.

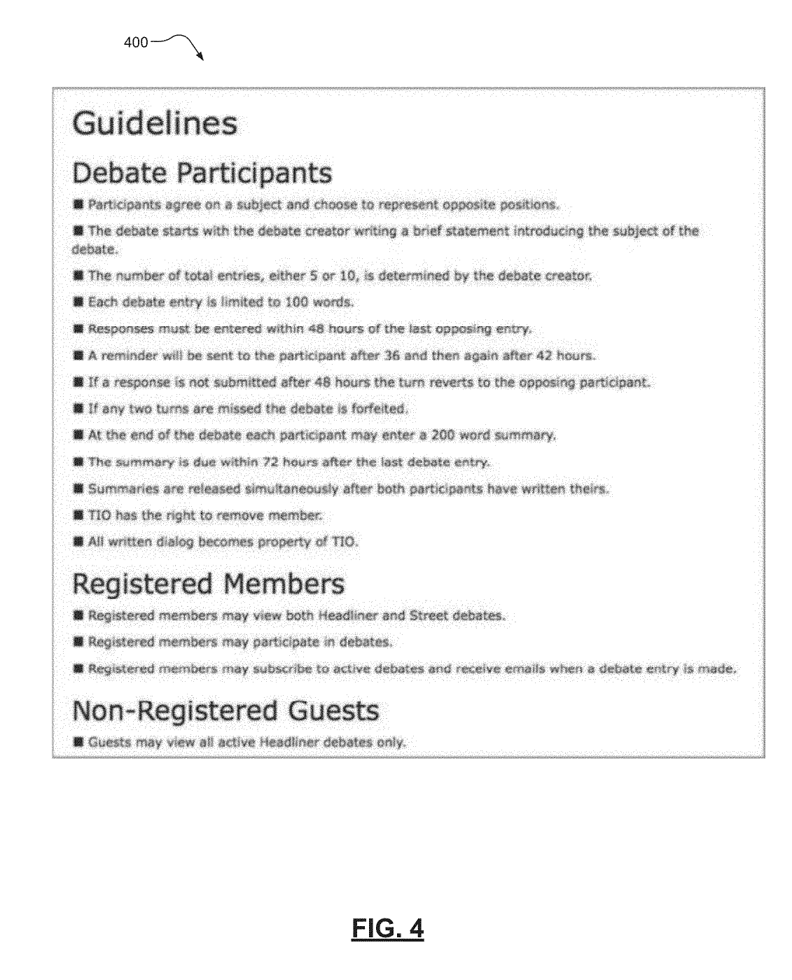

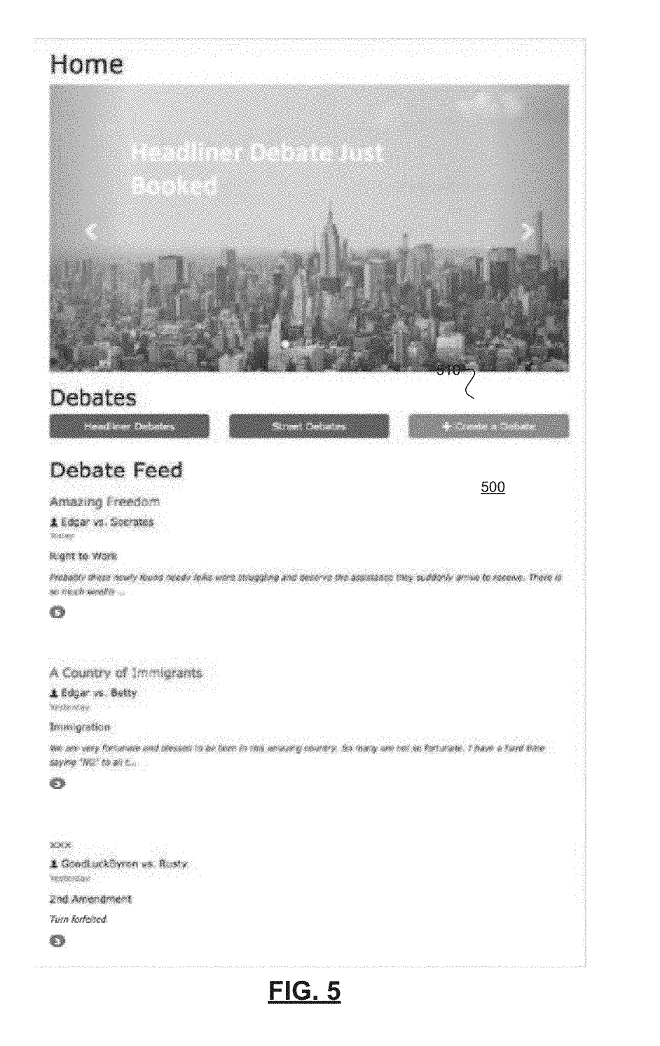

Upon initiating the debate application (launching an application, visiting the debate website, etc.) a user can arrive at a landing page 300, as shown in FIG. 3. The landing page 300 can include three buttons: the “First Visit” button 310 may link to an overview of the application without registering as a user; the “Guest Access” button 320 may provide a user with limited access to the application, e.g., the ability to view debates but not to participate; and the “Member Login” button 330 can provide full access to Headliner debates, any public Street debates, and any debates in which the user is/was a participant, as well as permit a user to create and participate in debates. In some aspects, the Login option requires a password or other form of authentication by the user. The application may also include guidelines 400 (FIG. 4) for debates that can be accessed by users. The guidelines 400 of FIG. 4 are merely example rules for the debate and can differ between implementations.

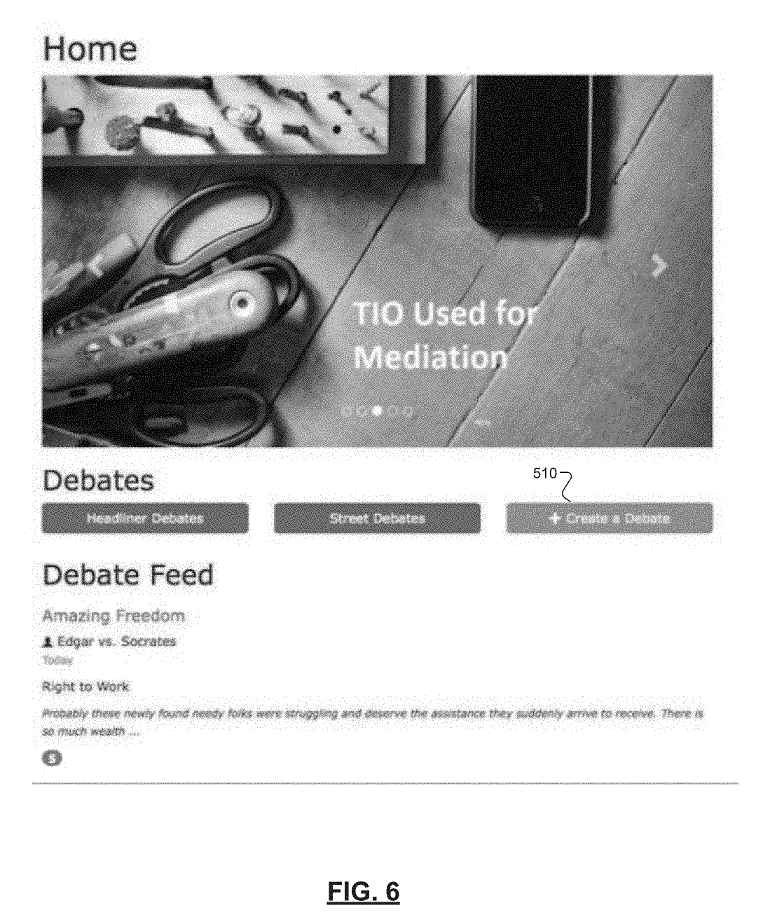

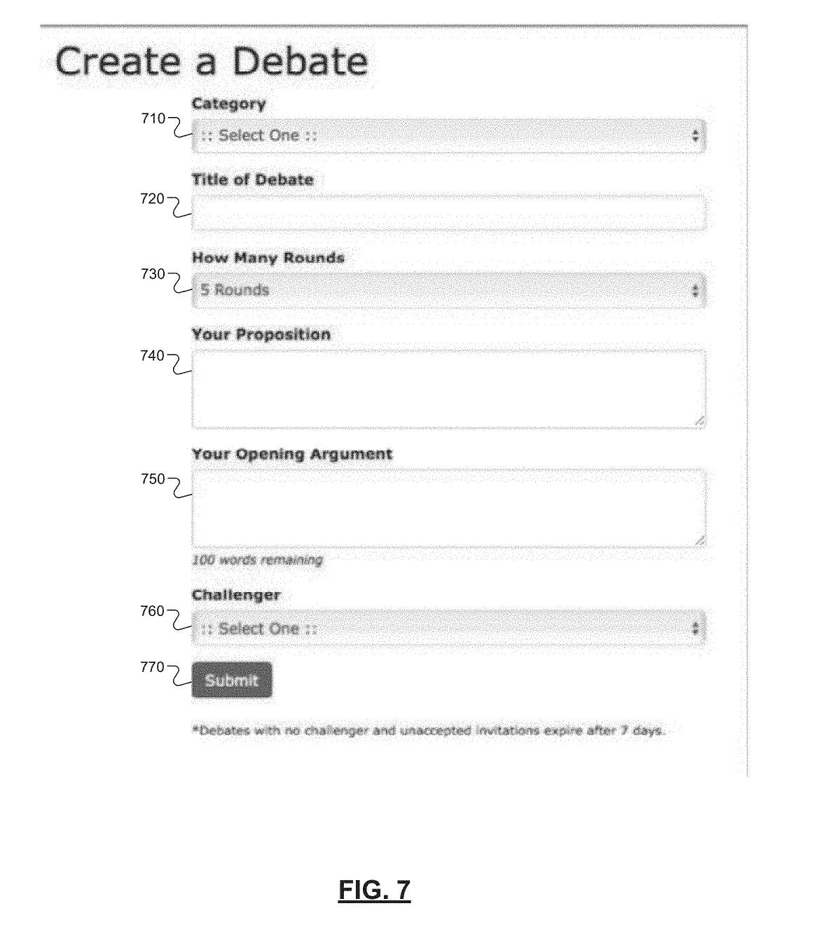

Upon selecting “Guest Access” button 320 or “Member Login” button 330, a user may be presented with a home page, such as the home page 500 illustrated in FIG. 5 and the home page 600 illustrated in FIG. 6. The home page 500, 600 can include multiple options, depending on whether or not the user has entered via the Guest Access or Member Login button 320, 330. When a user selects the “create a debate” button 510, the user can challenge another user to a debate via a debate creation page 700. For example only, and with reference to FIG. 7, a user can choose a category 710 for the debate, provide a topic or title 720 for the debate, select a number of rounds 730, and invite and identify a second user or “challenger” 760 for the debate. In the illustrated example, the user who creates the debate can provide their position or proposition on the debate via a proposition box 740. Further, the user can provide an argument (e.g., via an argument or opening argument box 750) that purports to support their position/proposition.

There can be options for invitations, e.g., by inviting registered users, invite a friend or person who is not yet a registered user, or an open invitation to any willing challenger. Challengers may be invited within the application, by entering an email (e.g., for a new user to the application), or in any other manner. If the user that is challenged accepts the offer to debate, both participant users will receive a link that they can send to others (friends, family, etc.) to invite them to view the debate. As shown, for example, in FIG. 7, and as mentioned above, a user or users can select a number of communications (rounds) 730 entries in the debate, such as 5, 10 or 15.

Each communication in the debate can be limited, e.g., to a specific number of words, characters, or length. If a user attempts to exceed the limit, he/she will not be able to submit the communication to the debate. Further, in some aspects, a profanity filter can be included in the application that prevents a communication with profanity or otherwise unacceptable content from being submitted to a debate. Alternatively or additionally, each communication can be moderated, e.g., by a human, a machine learning application, and/or an Artificial Intelligence algorithm, to ensure acceptable content.

After a participant user submits a communication entry, the opposing participant user may be given a limited time in which to respond (e.g., 48 hours). Reminders can be sent to the user(s) at intervals before the time limit (at 36 hours and/or at 42 hours). If a participant user fails to submit a communication within the time limit, the debate may be forfeited or otherwise end. In some aspects, after completing the agreed upon number of rounds, each participant can be permitted to provide a summation or summary of their position. Similar to all communications, the summaries can also include a length limit, which may be the same as, less than, or more than that of other communications. The summaries can be published by the application simultaneously so that neither user participant gets a last word (both get a last word, depending how you look at it). Such summaries can also have a time limit in which to be submitted (e.g., 72 hours to be submitted).

In some aspects, registered users can be permitted to view all of their debates in a personal archive, which may not be available to other users. In a user's personal drop down menu (FIG. 6), a user can access her/his active debates and archived debates. The application can also provide a worksheet or notes option for a user where that user can keep notes about debate(s) for future reference. Users can also subscribe to debates. Such visitor users who subscribe to a debate can receive notification (emails, etc.) whenever there is a new entry to that debate.

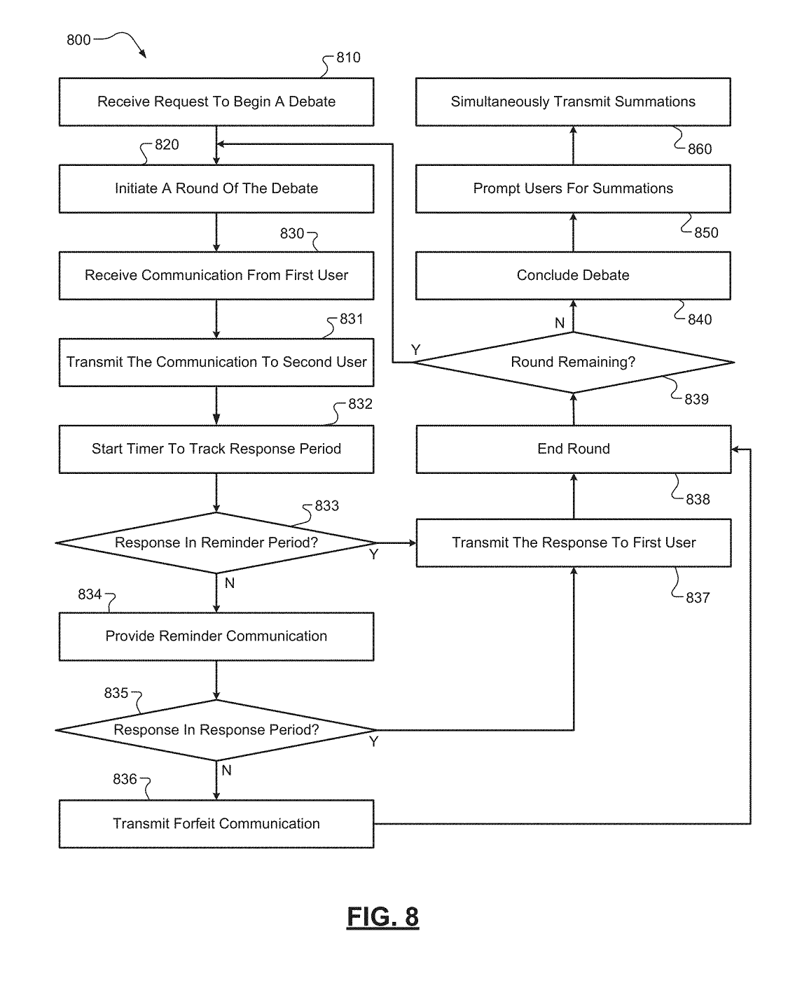

With further reference to FIG. 8, a computer-implemented method 800 for facilitating debate between a first user and a second user is shown. The method 800 can be performed by any computing device or devices. In some example implementations, the method 800 can be performed by a server computing device that is in communication with client computing devices with which the users interact. Alternatively, the method 800 can be performed by a combination of a server computing device and one or more client computing devices operating in conjunction. For ease of description, the method 800 will be described hereinafter as being performed by a single computing device (a server computing device) in communication with one or more client computing devices associated with the participants of the debate.

At 810, a computing device receives a request to begin a debate, such as by a first user selecting the “create a debate” button 510 and filling in the fields of the debate creation page 700. As illustrated, the request identifies a topic (such as the title 720) of the debate, a number of rounds 730 for the debate, and a second user or challenger 760 with whom the first user wishes to debate. In some aspects, the first user can utilize their client computing device to create the request, which is transmitted to a server computing device upon selection of a “submit” button 770. At 820, the server computing device will initiate each round of the debate during which the first and second user alternate providing communications regarding the topic to the computing device.

During each round of the debate, the server computing device will receive (830) a communication from the first user. The communication can provide a first position or proposition (740) on the topic (720) as well as a first argument (750) purporting to support the first position (740). Upon receiving the communication, the server computing device will transmit (831) the communication to the second user and start (832) a time to track a response period. The response period provides a time limit in which the second user is permitted to respond to the communication. Further, in some instances, the response period can further include a reminder period shorter than the response period. The reminder period can be utilized to provide a reminder to the second user to respond to the first user's communication. For example only, when the second user has not provided (833) a response to the first user's communication within the reminder period, the server computing device can provide (834) a reminder communication to the second user indicative of the response period, the time remaining in the response period, or the like.

In certain implementations, when the second user has not provided (835) the response within the response period, the server computing device can transmit (836) a forfeit communication to the first and second users indicating that the second user has forfeited their turn for the round. When the second user does provide (835) the response within the response period, the server computing device can transmit (837) the response to the first user. The response can provide a second position on the topic different from the first position and include a second argument purporting to support that second position. In either case, when the second user has either (i) forfeited their turn for the round, or (ii) provided the response for the round within the response period, the server computing device can end (838) the round.

At 839, if there are remaining rounds in the debate, the method 800 can return to 830 at which the server computing device can receive a communication from the first user. Although it is not specifically illustrated, it should be appreciated that, in certain implementations, the first user can also be subjected to a response period as described above in relation to the second user. Accordingly, in such implementations, the first user may forfeit their turn to provide a communication during a round if the first user fails to provide such a communication during the response period. In order to ensure that a debate stays active and engaging, in various aspects the server computing device may conclude a debate a certain number of turns have been forfeited, e.g., if more than one turn has been forfeited by the either user or both users combined.

At 839, if there are no remaining rounds in the debate, the method 800 can proceed to 840 at which the server computing device concludes the debate. The debate can be concluded by the server computing device prompting (850) the first and second users to provide a first and second summation, respectively, of their respective positions. Similar to the communication and response size limits described above, the summations may also or alternatively be subjected to a size limit. In some implementations, the summation size limit is larger than the size limit for the communication(s) and response(s) to permit the users to fully summarize their positions. As mentioned above, the size limit and the summation size limit can correspond to a number of characters or number of words.

In some aspects, a summation period can be applied to receiving the summations, similar to the response period. Accordingly, in such implementations, a user may forfeit their turn to provide their summation if they fail to provide their summation during the summation period. Further, in some aspects concluding the debate can further include providing a summation reminder to the first and/or second users when that user has not yet provided their summation and a remaining time in the summation period is below a threshold. For example only, providing the summation reminder can include starting the timer to track the summation period and the remaining time in the summation period, as described above in regard to the response period.

At 860, the server computing device simultaneously transmits the first summation to the second user and the second summation to the first user upon receipt of: (i) both the first and second summations, or (ii) the end of the summation period. In this manner, each of the first and second users can have the “final word” in the debate and neither user can respond to the summation of the other user. Such simultaneous transmission of the summations can provide various benefits to the debate, including but not limited to eliminating the advantage of a debate participant having the final word and allowing both users to submit an argument to which the other user is unable to respond.

In some implementations, the server computing device can screen each of the communications, responses, and summations for inappropriate content. For example only, the server computing device can utilize a machine learning application or Artificial Intelligence system to determine inappropriate content. Alternatively or additionally, the screening process may be performed by a moderator, human or otherwise (e.g., a separate application or computer-based system accessed via an application programming interface or the like) configured to determine inappropriate content. When a communication, response, and/or a summation is determined to contain inappropriate content, such communication, response, and/or a summation is not transmitted to another user. Additional actions may be taken by the server computing device when inappropriate content is determined, such as ending a debate, censuring the transmitting user, and revoking the user's membership to the debate application.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known procedures, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The term “and/or” includes any and all combinations of one or more of the associated listed items. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

It should be appreciated that the term “computing device” as used herein refers to any suitable device or set of multiple devices that is/are configured to perform at least a portion of the techniques of the present disclosure. Non-limiting examples include an application-specific integrated circuit (ASIC), one or more processors and a non-transitory memory having instructions stored thereon that, when executed by the one or more processors, cause the processors to perform a set of operations corresponding to at least a portion of the techniques of the present disclosure. The one or more processors could be either a single processor or two or more processors operating in a parallel or distributed architecture.

Unless specifically stated otherwise as apparent from the above discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system memories or registers or other such information storage, transmission or display devices.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A computer-implemented method for facilitating debate between a first user and a second user, comprising:
receiving, at a computing device have one or more processors, a request to begin a debate, the request being from the first user and identifying a topic of the debate, a number of rounds for the debate, and the second user;
initiating, at the computing device, each round of the debate during which the first and second user alternate providing communications regarding the topic to the computing device;
during each round of the debate:
receiving, at the computing device, a communication from the first user, the communication providing a first position on the topic and comprising a first argument purporting to support the first position;
upon receiving the communication:
transmitting, from the computing device, the communication to the second user, and
starting, at the computing device, a timer to track a response period, the response period providing a time limit in which the second user is permitted to respond to the communication, wherein the response period further includes a reminder period shorter than the response period;
when the second user has not provided a response within the reminder period, providing, from the computing device, a reminder communication to the second user indicative of the response period;
when the second user has not provided the response within the response period, transmitting a forfeit communication to the first and second users indicating that the second user has forfeited their turn for the round;
when the second user provides the response within the response period, transmitting the response to the first user, wherein the response provides a second position on the topic different from the first position and comprises a second argument purporting to support the second position;
when the second user has either (i) forfeited their turn for the round, or (ii) provided the response for the round within the response period: ending, at the computing device, the round; and
when there are no remaining rounds in the number of rounds, concluding the debate by:
prompting the first and second users to provide a first and second summation, respectively, of their respective positions, and
simultaneously transmitting the first summation to the second user and the second summation to the first user upon receipt of: (i) both the first and second summations, or (ii) an end of a summation period.

2. The computer-implemented method of claim 1, wherein concluding the debate further comprises providing a summation reminder to a particular user of the first and second users when the particular user has not yet provided their summation and a remaining time in the summation period is below a threshold.

3. The computer-implemented method of claim 2, wherein providing the summation reminder to the particular user comprises starting the timer to track the summation period and the remaining time in the summation period.

4. The computer-implemented method of claim 1, wherein the communication and the response are subject to a size limit.

5. The computer-implemented method of claim 4, wherein the first and second summations are subject to a summation size limit.

6. The computer-implemented method of claim 5, wherein the summation size limit is larger than the size limit for the communication and response.

7. The computer-implemented method of claim 5, the size limit and the summation size limit corresponds to a number of characters or number of words.

8. The computer-implemented method of claim 1, further comprising:
screening, at the computing device, each of the communications, responses, and first and second summations for inappropriate content, wherein any of the communications, responses, and first and second summations that contain inappropriate content is not transmitted to another user.

9. The computer-implemented method of claim 8, wherein screening each of the communications, responses, and first and second summations for inappropriate content comprises utilizing a machine learning application or Artificial Intelligence system to determine inappropriate content.

10. The computer-implemented method of claim 1, further comprises concluding the debate when more than one turn has been forfeited.

11. A computing device configured for facilitating debate between a first user and a second user, comprising:
one or more processors; and
a non-transitory computer-readable storage medium having a plurality of instructions stored thereon, which, when executed by the one or more processors, cause the one or more processors to perform operations comprising:
receiving a request to begin a debate, the request being from the first user and identifying a topic of the debate, a number of rounds for the debate, and the second user;
initiating each round of the debate during which the first and second user alternate providing communications regarding the topic to the computing device;
during each round of the debate:
receiving a communication from the first user, the communication providing a first position on the topic and comprising a first argument purporting to support the first position;
upon receiving the communication:
transmitting the communication to the second user, and
starting a timer to track a response period, the response period providing a time limit in which the second user is permitted to respond to the communication, wherein the response period further includes a reminder period shorter than the response period;
when the second user has not provided a response within the reminder period, providing a reminder communication to the second user indicative of the response period;
when the second user has not provided the response within the response period, transmitting a forfeit communication to the first and second users indicating that the second user has forfeited their turn for the round;
when the second user provides the response within the response period, transmitting the response to the first user, wherein the response provides a second position on the topic different from the first position and comprises a second argument purporting to support the second position;
when the second user has either (i) forfeited their turn for the round, or (ii) provided the response for the round within the response period: ending the round; and
when there are no remaining rounds in the number of rounds, concluding the debate by:
prompting the first and second users to provide a first and second summation, respectively, of their respective positions, and
simultaneously transmitting the first summation to the second user and the second summation to the first user upon receipt of: (i) both the first and second summations, or (ii) an end of a summation period.

12. The computing device of claim 11, wherein concluding the debate further comprises providing a summation reminder to a particular user of the first and second users when the particular user has not yet provided their summation and a remaining time in the summation period is below a threshold.

13. The computing device of claim 12, wherein providing the summation reminder to the particular user comprises starting the timer to track the summation period and the remaining time in the summation period.

14. The computing device of claim 11, wherein the communication and the response are subject to a size limit.

15. The computing device of claim 14, wherein the first and second summations are subject to a summation size limit.

16. The computing device of claim 15, wherein the summation size limit is larger than the size limit for the communication and response.

17. The computing device of claim 15, the size limit and the summation size limit corresponds to a number of characters or number of words.

18. The computing device of claim 11, further comprising:
screening each of the communications, responses, and first and second summations for inappropriate content, wherein any of the communications, responses, and first and second summations that contain inappropriate content is not transmitted to another user.

19. The computing device of claim 18, wherein screening each of the communications, responses, and first and second summations for inappropriate content comprises utilizing a machine learning application or Artificial Intelligence system to determine inappropriate content.

20. The computing device of claim 11, further comprises concluding the debate when more than one turn has been forfeited.
